(19) United States
(12) Patent Application Publication
(10) Pub. No.: US 2019/0086367 A1
(43) Pub. Date: Mar. 21, 2019

(54) In-Line Inspection Tool with Continuous Band Assemblies

(71) Applicant: Baker Hughes, a GE company, LLC, Houston, TX (US)

(72) Inventors: Mikhail Anisimov, Calgary (CA); Peter Plichta, Mississauga (CA)

(73) Assignee: Baker Hughes, a GE company, LLC, Houston, TX (US)

(21) Appl. No.: 15/708,857

(22) Filed: Sep. 19, 2017

(51) Int. Cl. G01N 29/22; G01N 29/04; G01N 27/04

(52) U.S. Cl. CPC G01N 29/225; G01N 2291/262; G01N 27/041; G01N 29/04

(57) ABSTRACT

A pipe inspection tool having a central shaft assembly with at least one continuous band assembly which extend radially outwardly therefrom into contact with a surrounding pipe. The continuous band assembly includes a continuous band which carries at least one pipe inspection element and a roller which circulates the continuous band in order to form stationary, non-sliding contact between the pipe inspection element and the surrounding pipe over a period of time during which the pipe inspection tool moves within the pipe.

### BACKGROUND OF THE INVENTION

### 1. Field of the Invention

The invention relates generally to the design of in-line pipe inspection tools.

### 2. Description of the Related Art

Pipelines often carry liquids and gases under high pressure. The carried liquids and gases may contain solids or corrosives which can damage the pipeline. Thus, it has become increasingly important to monitor the interior surfaces of pipelines to be able to correct physical damage, corrosion, rust, contamination or other problems.

In-line pipe inspection tools are used to examine the interior surfaces of pipelines to ensure their integrity. One variety of in-line pipe inspection tool is commonly referred to as a pig. Pigs travel within the pipeline under pressure. Many contemporary in-line inspection tools contain on-board sensors and data recording equipment. As a result, they are often referred to as “smart” pigs.

One type of in-line inspection tool is a tool that measures the voltage differential along the inner surface of the pipe. The inspection tool provides a measure of the effectiveness of applied corrosion protection for a pipeline and the need for corrective actions to be taken to prevent problematic corrosion. The tool measures a voltage drop across a short distance of the pipeline. To do this, the tool provides two distinct electrical contact points with the pipeline wall which are separated by a known distance. The measured voltage drop is then used to calculate the DC current and current density.

Current designs for pipe inspection tools incorporate either rotating steel knives or, more typically, bare steel rotary brushes to form the electrical contact points. The brushes are intended to slide or roll along the interior surface of the pipeline as the tool moves through the pipeline under the impetus of pressurized fluid. Contact between the brushes is intermittent because the contact point moves constantly as the tool moves through the surrounding pipe. Additionally, the contact points are subject to vibration during operation which leads to variability in contact pressure and increased undesirable friction and temperature. In dry gas environments, these effects become even worse as compared to liquid pipelines. Increased dynamics at the contact surfaces (bristles) introduce background noise even where there is perfect electrical contact with the surface of the pipe.

### SUMMARY OF THE INVENTION

The invention provides pipe inspection tools having an improved design for contacting a pipeline wall and yielding improved data relating to the condition of the pipeline. Pipe inspection tools are described which provide for stationary, non-sliding contact between a pipe inspection element and the interior surface of the pipeline for a period of time even as the tool moves axially through the surrounding pipe. Further movement of the tool through the pipe will remove the pipe inspection element from stationary contact with the interior surface and, subsequently, re-establish stationary contact between the pipe inspection element and the interior pipe surface. The described tool design provides for increased time for obtaining measurement of one or more pipe condition parameters at the pipe wall and yielding more accurate data. In some embodiments, the pipe condition parameter is a voltage differential measurement. In other embodiments, the pipe condition parameter is a hardness, acoustic, ultrasonic or other property which is measured by a sensor.

Exemplary inspection tools are described which include a central shaft assembly that preferably carries several flexible shaped cups designed to capture fluid to move the tool through a pipe along with fluid within the pipe. In certain embodiments, used to measure voltage drop, at least one first continuous band assembly and at least one second continuous band assembly are carried by the central shaft assembly. Preferably, sets of first and second continuous band assemblies are spaced apart from one another upon the shaft assembly by a predetermined distance. However, if differential measurement is not required, at least one continuous band assembly can be utilized on the tool carried by the central shaft assembly.

In certain embodiments, the described pipe inspection tools include a measurement device for measuring the amount of voltage drop along the pipeline between the continuous band assemblies if more than one continuous band assembly is used.

Each of the continuous band assemblies includes a continuous band in the form of a track, loop or belt which is driven by one or more rollers in a circuitous manner. In a described embodiment, the continuous band assembly includes a continuous band in the form of a chain drive which is carried by a roller assembly in the form of a sprocket assembly that engages and circulates the chain drive around several sprockets of the sprocket assembly. However, the continuous track or loop of the continuous band assembly could also be made up of a belt of fabric and/or elastomer which is driven by rollers. Furthermore, the continuous band assembly could have a different cross-sectional geometry. The continuous bands of these continuous band assemblies each carry one or more conductive contacts which are operably interconnected with the voltage measurement device. The conductive contacts may be in the form of brushes, probes or other forms which are adapted to permit electrical contact. In a described embodiment, the conductive contacts are in the form of a conductive tuft assembly which conducts electricity between the interior surface of the surrounding pipe and a conductive strip.

An alternative continuous band assembly is described which includes elongated conductive contact carriers that are secured to the continuous band at one axial end. The opposite axial end of the contact carrier carries a follower pin which moves within a channel on the carriage of the continuous band assembly. As the continuous band is circulated upon the sprocket assembly, the contact carriers are moved laterally and radially to create contact with the surrounding pipe. Circulation of the continuous band will cause the contact carriers to be moved so that the conductive contacts are brought into electrical contact with the surrounding pipe. The conductive contacts are preferably retained within conductive contact platforms which are pivoted with respect to the continuous band in order to orient the conductive contact for effective contact with the interior surface of the pipe. In this design, the conductive contact carriers are connected with the voltage measurement device by a conductive wire.

In operation, this exemplary pipe inspection tool is disposed into a surrounding pipe so that the wheels of each continuous band assembly are in contact with the interior surface of the pipe. As the pipe inspection tool is moved axially through the pipe, rotation of the wheels will rotate the sprockets of the sprocket assembly of each continuous band assembly which will circulate the continuous band about the sprocket assembly. As the continuous band is circulated, conductive contacts are brought into contact with the interior surface of the surrounding pipe.

Due to the circulation of the continuous bands, stationary electrical contact between the surrounding pipe and one or more of the conductive contacts is maintained over a period of time even as the tool continues to move through the pipe. In particular, the tool can move axially through the pipe while the conductive contacts are maintained in stationary contact with the interior surface.

The invention also provides methods for measuring a voltage differential within a pipe wherein a voltage differential measurement tool is used that is axially moveable through the pipe. In accordance with these methods, a pair of conductive contacts are urged radially outwardly into stationary electrical contact with the pipe. The “pair” of conductive members would include a first conductive contact from a forward continuous band assembly and a second conductive contact from a rearward continuous band assembly. The pair conductive contacts maintain a stationary electrical contact with the pipe for a period of time during which a voltage differential is measured over a distance “d” through the pair of conductive contacts.

A further alternative continuous band assembly is described wherein the continuous band takes the form of a continuous flexible belt which is circulated about roller assembly. The belt carries at least one pipe inspection element in the form of a probe assembly which will be brought into stationary contact with the interior surface of the pipe as the inspection tool moves along the pipe. In this embodiment, the belt itself is in contact with the interior pipe surface as the tool moves axially along the pipe. Contact between the belt and interior surface rotates the rollers of the roller assembly.

### BRIEF DESCRIPTION OF THE DRAWINGS

For a thorough understanding of the present invention, reference is made to the following detailed description of the preferred embodiments, taken in conjunction with the accompanying drawings, wherein like reference numerals designate like or similar elements throughout the several figures of the drawings and wherein:

FIG. 1 is a side, cross-sectional view of an exemplary in-line pipe inspection tool which incorporates continuous band assemblies in accordance with the present invention.

FIG. 2 is an axial view taken along lines 2-2 in FIG. 1.

FIG. 3 is an isometric view of a single exemplary continuous band assembly.

FIG. 4 is an end view of an exemplary continuous band assembly.

FIG. 5 is an enlarged isometric view of an end of the continuous band assembly of FIGS. 3 and 4.

FIG. 6 is a side view of an exemplary conductive tuft used in the continuous band assembly of FIGS. 3-5.

FIG. 7 is a side, cross-sectional view of the tuft shown in FIG. 6.

FIG. 8 is an isometric view of portions of a continuous band assembly.

FIG. 9 is an isometric view of an alternative continuous band assembly constructed in accordance with the present invention.

FIG. 10 is an enlarged isometric view of the continuous band assembly shown in FIG. 9.

FIG. 11 is a diagram illustrating movement of follower pins within a channel.

FIG. 12 is an isometric view of portions of an alternative continuous band assembly which incorporates a continuous belt.

FIG. 13 is a side, cross-sectional view of the continuous band assembly shown in FIG. 12.

FIG. 14 is a cross-sectional view taken along lines 14-14 in FIG. 13.

FIG. 15 is a detail view of the area designated as 15 in FIG. 14 showing details of the probe assembly.

FIG. 16 is an isometric view of an exemplary alternative probe assembly apart from other components of a continuous band assembly.

FIG. 17 is a cross-sectional view of the probe assembly shown in FIG. 16.

FIG. 18 is a side, cross-sectional view of an exemplary pipe inspection tool which incorporates continuous band assemblies in conjunction with pipe inspection sensors.

### DETAILED DESCRIPTION OF THE PREFERRED EMBODIMENTS

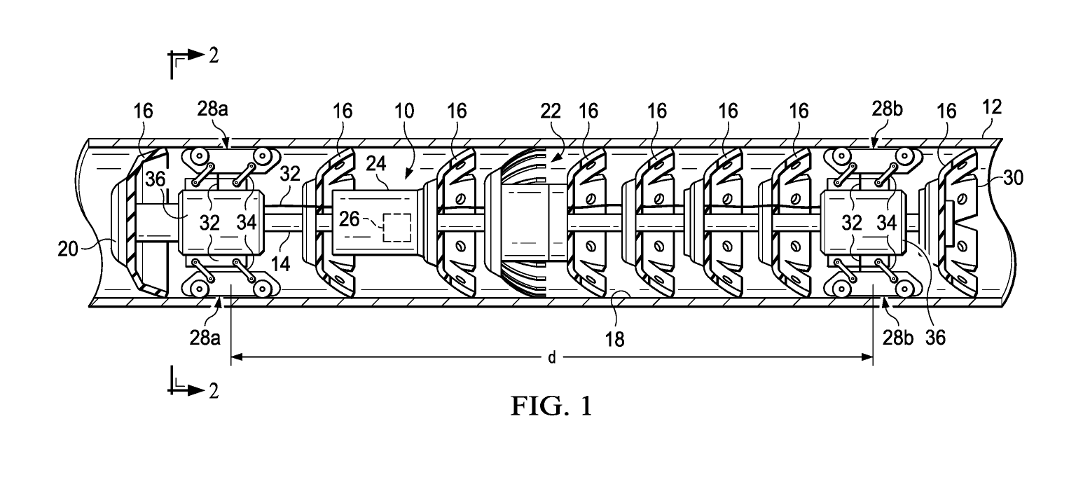

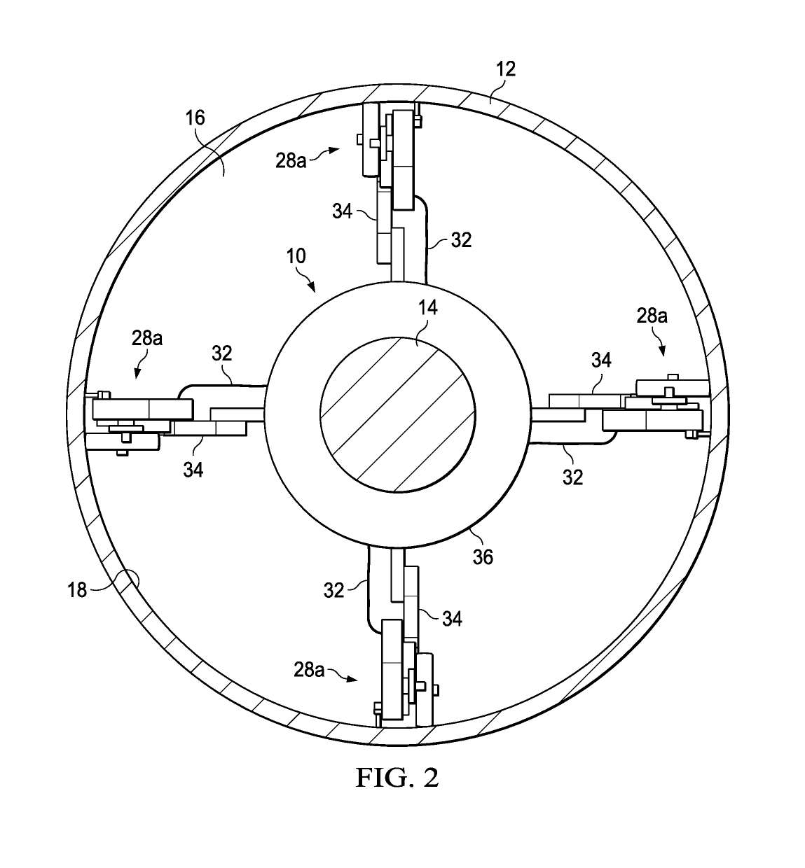

FIGS. 1 and 2 depict an exemplary in-line pipe inspection tool or device 10 which is disposed within a radially surrounding pipe 12 which may be a portion of a pipeline to be inspected. The tool 10 may also be referred to herein as a voltage differential measurement tool in view of its capacity to apply a voltage differential to a portion of the pipe 12 and measure the differential. The tool 10 includes a central, elongated shaft assembly 14 which carries a plurality of shaped cups 16 for capturing fluid. The shaft assembly 14 may be of unitary construction but is more typically made up of a series of interconnected subs and shaft sections which are secured to one another in a sequential fashion. The shaft assembly 14 is maintained toward the center axis of the pipe 12 by cups 16 as the tool 10 is moved within the pipe 12.

The cups 16 are typically formed of polyurethane or another flexible material. During operation, the cups 16 typically contact the inner surface 18 of the surrounding pipe 12 and function to centralize the shaft assembly 14 within the pipe 12. In addition, the cups 16 are curved to capture pressurized fluid which helps move the CPCM tool 10 along the pipe 12. A generally conical nose cone 20 is located at the axial end of the central shaft assembly 14 and is the portion of the tool 10 which is inserted first into the pipe 12. The tool 10 carries a caliper section 22 which is used to detect deformation or alignment problems in a surrounding pipeline.

The tool 10 also includes a housing 24 which is mounted on or incorporated into the shaft assembly 14 and which contains an electrical voltage measurement device 26, such as a voltmeter, to measure the voltage drop across a portion of the pipe 12. In particular, the voltage measurement device 26 measures the amount of voltage drop between continuous band assemblies 28a, 28b. The measured voltage drop is then used to calculate the DC current and current density.

The tool 10 carries at least one, and can carry multiple, first and second continuous band assemblies, generally shown at 28a, 28b, respectively. However, the tool 10 could carry at least one continuous band assembly 28 when differential measurements are not required. When the voltage differential is measured between first and second sets of continuous band assemblies, the first continuous band assemblies 28a are located at the forward axial end of the tool 10, proximate the nose cone 20. The second continuous band assemblies 28b are located proximate the rear axial end 30 of the tool 10. It is noted that the first continuous band assemblies 28a are located a spaced distance (“d”) from the second continuous band assemblies 28b. Each continuous band assembly 28a, 28b is designed to contact the interior surface 18 of the pipe 12 through which the tool 10 is moving and ensure measurement of voltage drop by the voltage measurement device 26 upon the pipe surface 18. Electrical wiring 32 interconnects the voltage measurement device 26 with the continuous band assemblies 28a, 28b. Because the continuous band assemblies 28a, 28b are located a known, set distance (“d”) from one another, a drop in voltage between the two assemblies through the pipe surface 18 can be measured by the voltage measurement device 26.

Each continuous band assembly 28a, 28b is connected by a support arm 34 to a central hub 36 which is incorporated into the central shaft assembly 14. Multiple support arms 34, which extend radially outwardly from the hub 36 in multiple radial directions, are preferred to support the shaft assembly 14 regardless of the angular orientation of the tool 10 within the pipe 12.

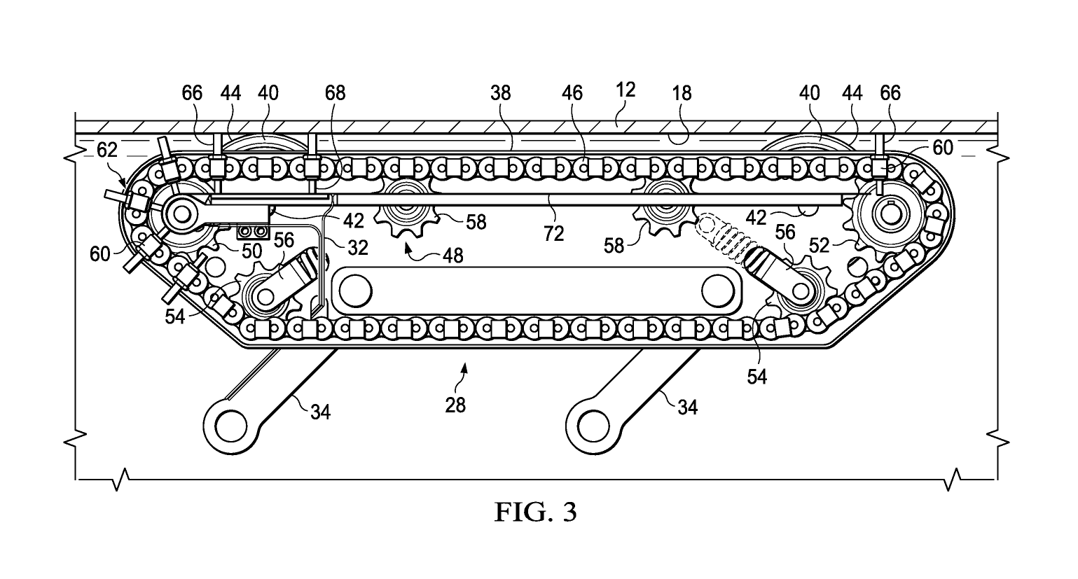

An exemplary continuous band assembly 28 is illustrated in FIGS. 3-5 apart from other components of the tool 10 and is representative of all of the first and second continuous band assemblies 28a and 28b. The continuous band assembly 28 includes an elongated carriage 38 which largely carries or supports the other components of the electrical contact platform assembly 28. Carriage 38 is directly supported by the support arms 34 as illustrated in FIGS. 3-5. The carriage 38 carries front and rear wheels 40, each of which are rotationally mounted upon an axis 42. Wheels 40 each present a radially outer contact surface 44 which contacts and rolls along the interior surface 18 of the pipe 12. The wheels 40 are preferably not electrically conductive. The outer contact surface 44 of the wheels 40 is preferably a traction surface (roughened or knurled) to minimize slip upon the pipe 12 during operation. The carriage 38 does not contact the interior surface 18 of the pipe 12 during use.

A continuous chain drive 46 is carried by a sprocket assembly 48 which includes forward and rear drive sprockets 50, 52. Both the forward sprocket 50 and the rear sprocket 52 are drive sprockets because they are driven by rotation of the axles 42 of their respective wheel 40. Preferably, the sprocket assembly 48 also includes idler sprockets 54 with compression spring-biased arms 56 which apply tension to the chain drive 46 to keep the chain drive 46 tight under tension during use. Additional sprockets 58 helps maintain alignment of the chain drive 46.

It is noted that the chain drive 46 is preferably made up of individual links which are affixed to one another by pins which permit relative pivoting movement between connected links. Thus, the chain drive 46 has a construction similar to that of a chain drive used with bicycles. Sprockets 50, 52, 54, 58 provide radially outwardly projecting teeth which intermesh with the chain links.

Each of the continuous band assemblies 28a, 28b includes a continuous band of material which is circulated by a plurality of rollers. In the depicted embodiment, the continuous band of material is a chain drive. However, it should be understood that the continuous band of material could comprise a continuous strip or belt formed of rubber and/or fabric, metal or other material. Also in the depicted embodiment, the rollers are toothed sprockets which engage the chain drive in order to circulate it. However, the rollers might also be wheels or other rotational members which are adapted to contact the continuous band and circulate it.

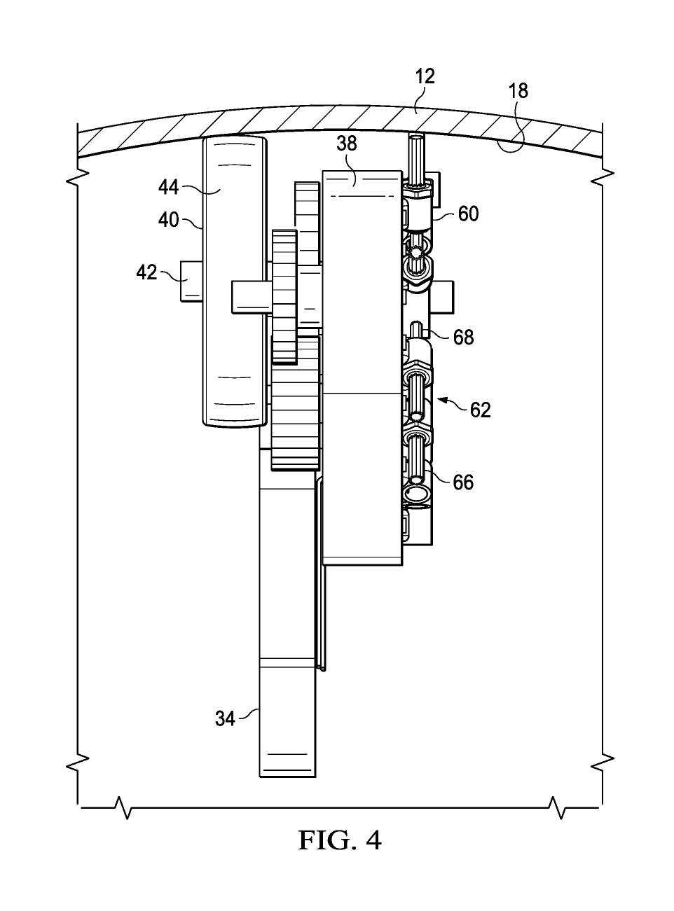

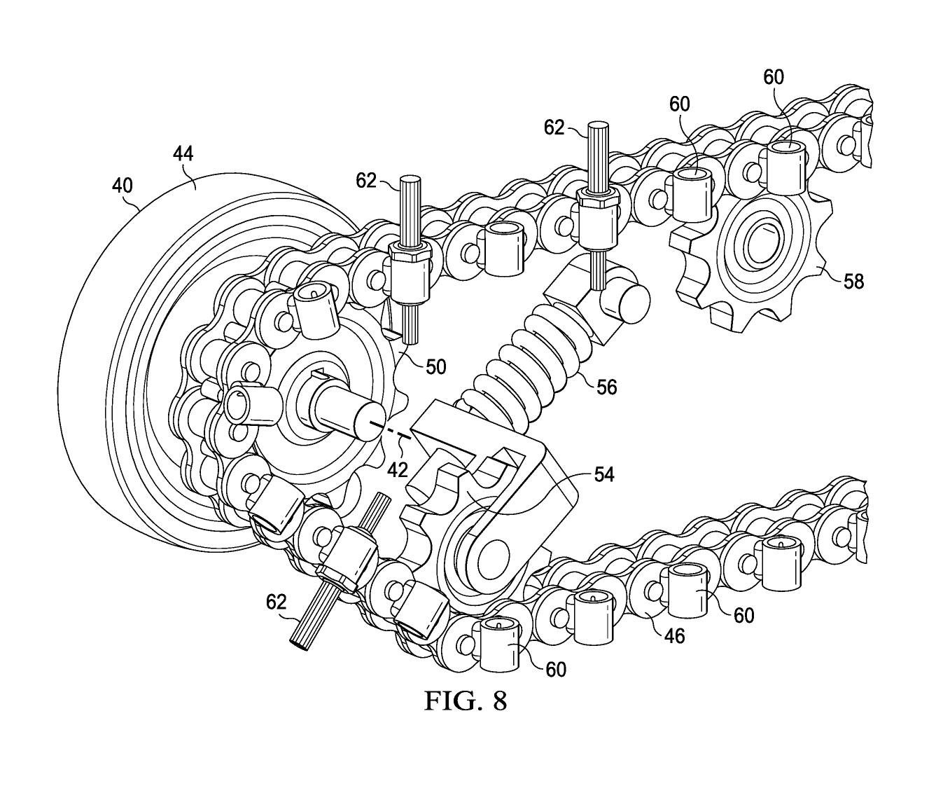

The chain drive 46 preferably carries one or more retaining sleeves 60, which are best seen in FIGS. 4, 5 and 8. There may be, as illustrated in FIGS. 3-5, a retaining sleeve 60 secured to every other adjacent link in the chain drive 46. Alternatively, the retaining sleeves 60 may be spaced further apart upon the chain drive 46.

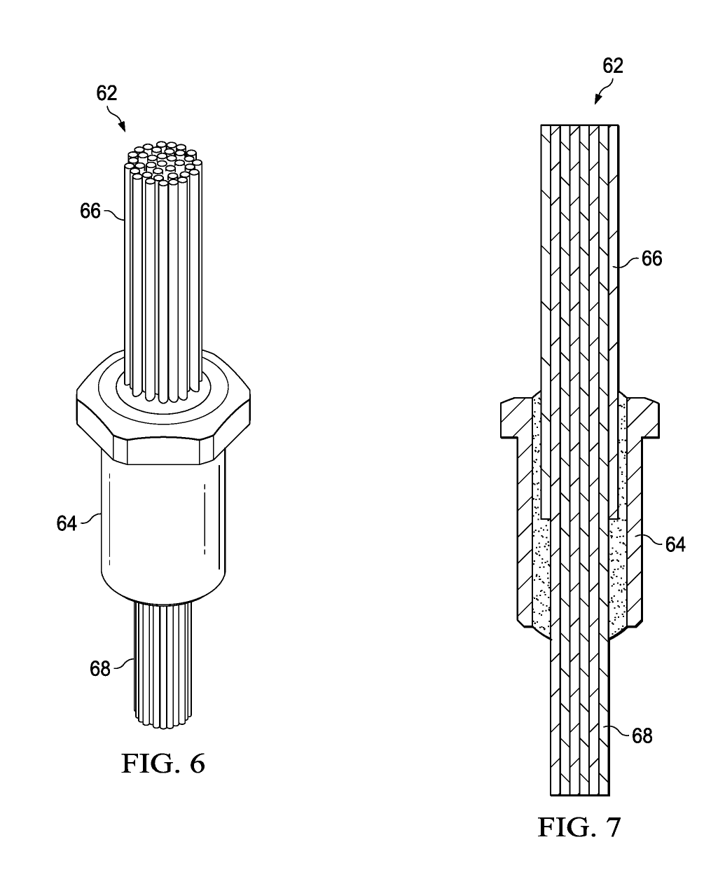

One or more of the retaining sleeves 60 retains a conductive tuft assembly 62 within. A single exemplary conductive tuft assembly 62 is illustrated in FIGS. 6-7. The tuft assembly 62 includes an outer sleeve 64 which is shaped and sized to reside within a retaining sleeve 60. Preferably, an outer conductive tuft 66 extends outwardly from the sleeve 64. An inner conductive tuft 68 also extends outwardly from the sleeve 64 in a generally opposite direction from the outer tuft 66. The tufts 66, 68 are preferably formed of bundles of bristles which are formed of electrically conductive material such as metal. In preferred embodiments, the inner and outer tufts 66, 68 are suspended within the outer sleeve 64 using an epoxy potting 70.

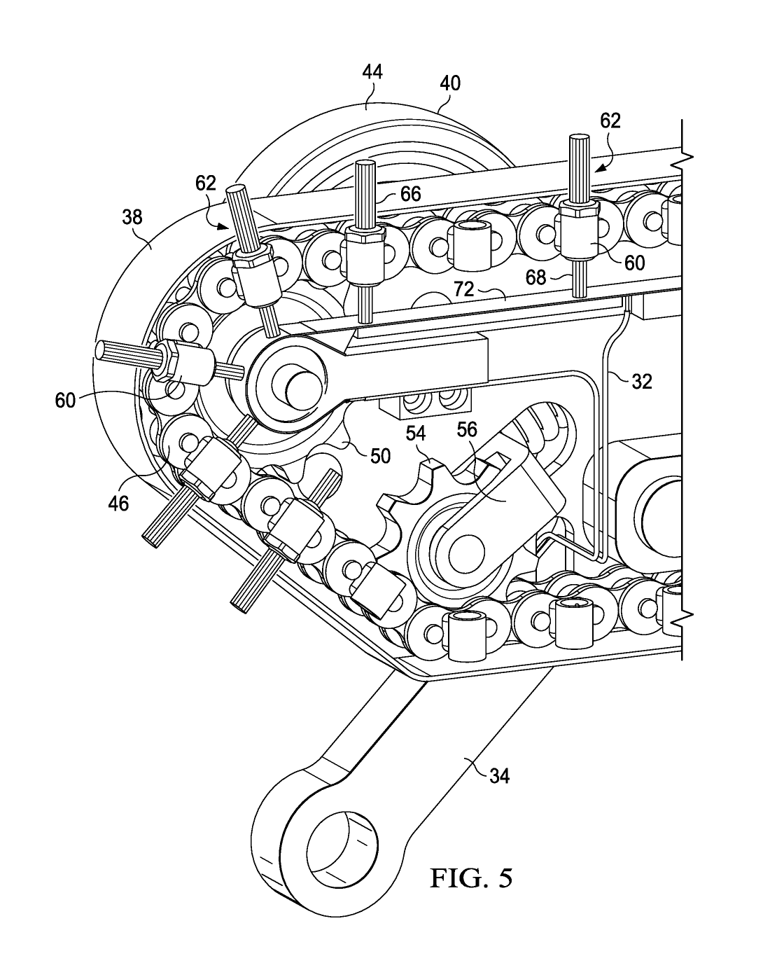

Referring once again to FIGS. 3 and 5, an electrically conductive strip 72 extends from the forward axle 42 to the rearward axle 42. A conductive plate 74 radially surrounds each of the axles 42. Electrical wiring 32 is used to operably associate the conductive plates 74 with the electrical voltage measurement device 26.

The sprocket assembly 48 engages and circulates the chain drive 46 around the drive sprockets 50, 52. As the chain drive 46 is circulated around the sprockets 50, 52, the outer conductive tufts 66 of the tuft assemblies 62 are brought into contact with the interior surface 18 of the pipe 12. During this time, the inner conductive tufts 68 of the tuft assemblies 62 are brought into contact with the conductive strip 72 (see FIGS. 3, 5). As a result, electrical communication is provided between the conductive strip 72 and the interior surface 18 of the pipe 12. The electrically conductive strip 72 is preferably electrically isolated from its retaining sleeve 60 except for the inner conductive tufts 68 and electrical wiring 32.

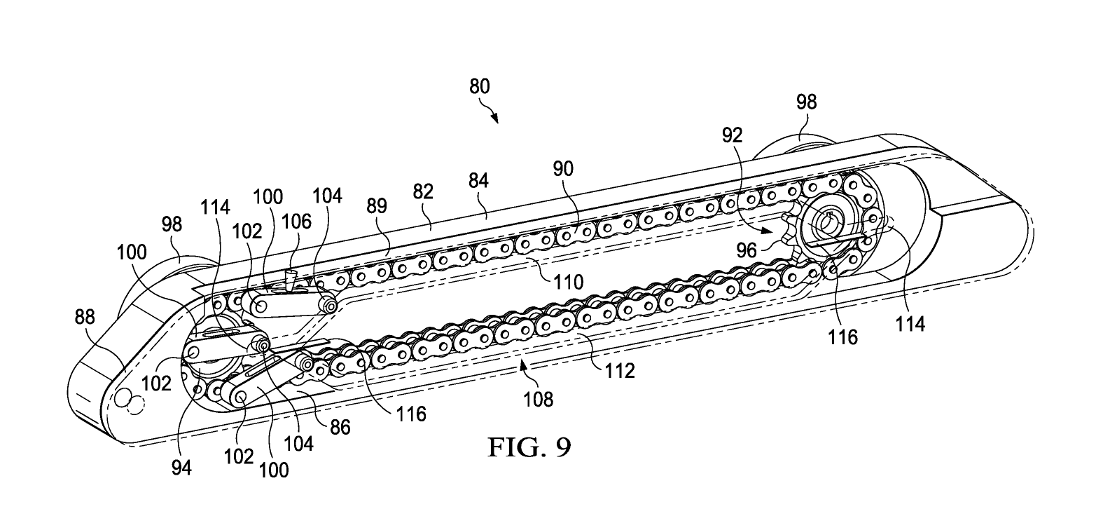

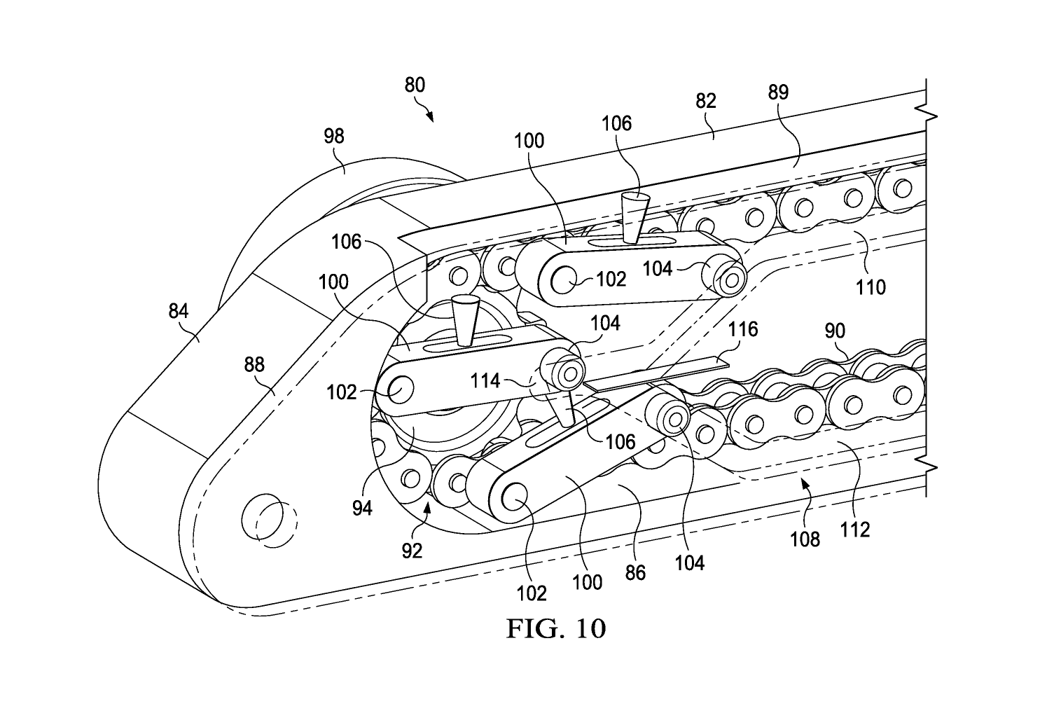

FIGS. 9-11 illustrate an alternative continuous band assembly 80 which is constructed in accordance with the present invention. The continuous band assembly 80 includes a carriage 82 which is supported by a support arm 34. The carriage 82 includes a main housing 84 which defines an interior cavity 86. A side cover panel 88 is shown in FIGS. 9-10 and, when affixed to the main housing 84, will enclose the interior cavity 86. An elongated slot 89 is formed upon the radially outer surface of the main housing 84.

A continuous band in the form of a continuous chain drive 90 is located within the interior cavity 86 and is carried by a roller assembly in the form of sprocket assembly 92. The sprocket assembly 92 includes front and rear sprockets 94, 96, respectively. Each of the sprockets 94, 96 is affixed to and rotates with a pipe-contacting wheel 98. Wheels 98 extend radially outwardly beyond the main housing 84 as shown. A number of conductive contact platforms 100 are operably associated with and carried by the chain drive 90. Three conductive contact platforms 100 are shown. However, it should be understood that there may be more or fewer than three and at least one. The conductive contact platforms 100 are elongated. A chain drive attachment pin 102 is located proximate one axial end of each platform 100 and secures each platform 100 to the chain drive 90. A follower pin 104 protrudes laterally from the opposite axial end of each platform 100. An electrically conductive contact 106 protrudes from the upper surface of each of the platform 100. The conductive contact 106 may be in the form of a brush or probe and are adapted to communicate electrically with the interior surface 18 of the surrounding pipe. It is noted that two of the platforms 100 in FIG. 9 are shown without conductive contacts in order to depict other components more clearly. Each of the conductive contacts 106 are in electrically conductive communication with the voltage measurement device 26 so that a voltage potential may be measured across the section of surrounding pipe 12 through the conductive contacts 106.

A channel 108 is formed in the side cover panel 88. The channel 108 includes an upper pin path 110 and lower pin path 112. At each axial end, the upper and lower pin paths 110, 112 converge to form single leg 114. The channel 108 is shaped and sized to receive each of the follower pins 104 and allow them to slide along the channel 108. A leaf spring 116 protrudes into each single leg 114.

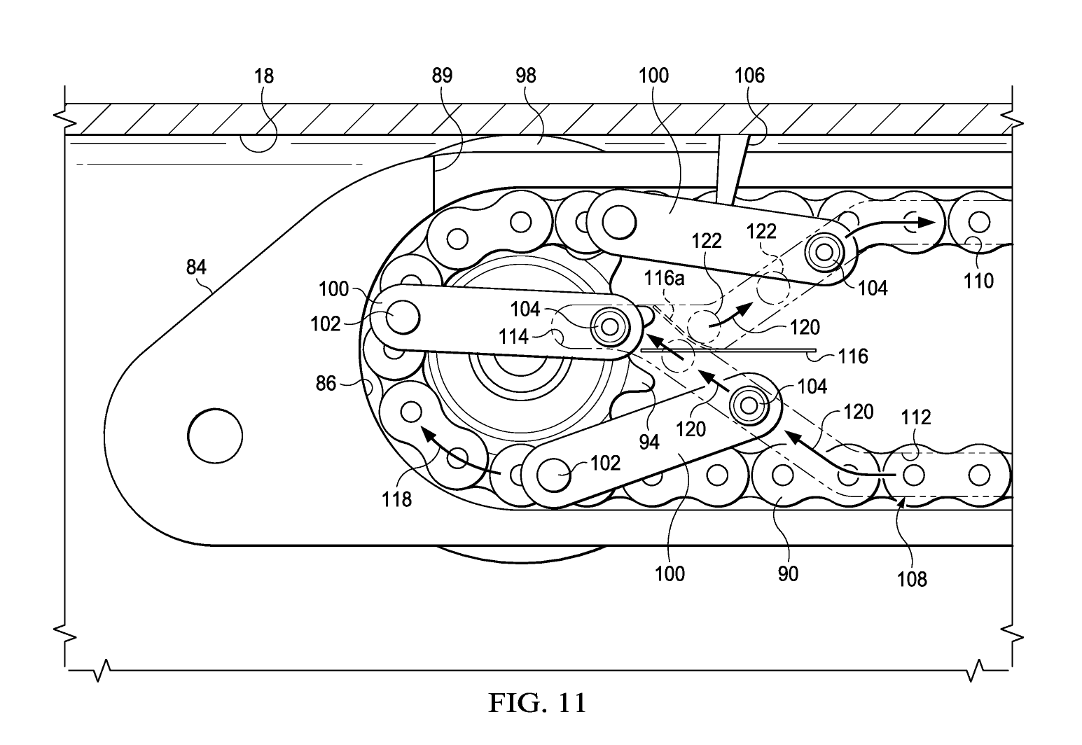

FIG. 11 helps illustrate movement of the follower pins 104 and platforms 100 during circulation of the chain drive 90. Follower pins 104 are located within the channel 108. Rolling of the wheel 98 upon the interior surface 18 of the surrounding pipe causes the chain drive 90 to circulate in the direction indicated by arrow 118. This movement causes the follower pins 104 to move within the channel 108 in the direction indicated by arrows 120 and indicated by phantom positions 122. Connection of the conductive contact platforms 100 to the chain drive 90 with the chain drive attachment pin 102 allows the platforms 100 to pivot with respect to the chain drive 90 as the chain drive 90 is circulated by the sprocket assembly 92 in order to orient the conductive contact 106 for effective contact with the interior surface 18 of the pipe 12.

The channel 108 will guide the conductive contact platforms 100 during circulation of the chain drive 90. As the follower pins 104 exit the lower pin path 112 and enter the single leg 114, the leaf spring 116 deforms upwardly (as indicated at 116a) to allow the follower pins 104. Further circulatory movement of the chain drive 90 will now move the follower pins 104 into the upper pin path 110 as the leaf spring 116 snaps back to its original, un-deformed position. A similar operation using a second leaf spring 116 occurs at the opposite axial end of the channel 108, thereby allowing the follower pins 104 to exit the upper pin path 110 and enter the lower pin path 112.

A single conductive contact 106 is shown in FIG. 11 making conductive contact with the interior pipe surface 18. However, it should be understood that a conductive contact 106 may be carried by each of the platforms 100. It should be understood that each of the follower pins 104 will eventually makes a complete circuit within the channel 108 such that conductive contacts 106 which are carried by the platforms 100 will be repeatedly brought into contact with the interior pipe surface 18. Electrically conductive contact is made with the surface 18 when the follower pins 104 are located within the upper pin path 110, allowing the associated conductive contacts 106 to extend through the elongated slot 89. It should be understood that the conductive contacts 106 will move within and along the slot 89 as the tool 10 moves axially through the pipe 12, thereby maintaining a stationary electrically conductive contact during movement of the tool 10.

In operation, the inspection tool 10 is disposed into a pipe or pipeline 12, as depicted in FIG. 1. Pressurized fluids, which are captured by the cups 16, move the tool 10 axially along the pipe 12 in the direction of arrow 88 in FIG. 1. The wheels 40 of each continuous band assembly 28 or 80 will contact and roll along the interior surface 18 of the pipe 12 during this time. Rotational energy from rotation of the wheels 40, 98 rotates drive sprockets of the sprocket assemblies 48 or 92 to circulate the chain drives 46 or 90 and create stationary electrically conductive contact with the surrounding pipe 12, as described.

The invention provides methods for measuring a voltage differential within a portion of a pipe 12. In accordance with described methods, a voltage differential measurement device, such as tool 10 having at least one continuous band assembly 28 or 80 is disposed into the pipe 12, and the tool 10 moves axially through the pipe 12 under the impetus of fluid flowing through the pipe 12. Stationary electrical contact is made between a conductive member or conductive contact 62 or 106 of the continuous band assembly 28 or 80 and an interior surface 18 of the pipe 12 which is useful for measuring a voltage differential within a portion of pipe 12. Stationary electrical contact is maintained between the conductive contact 62 or 106 and the interior surface 18 as the tool 10 moves a distance axially through the pipe 12. Thereafter, the conductive contacts 62, 106 are moved to a radially inward position, thereby breaking the stationary electrical contact. In accordance with described methods, stationary electrical contact is maintained while the tool 10 moves axially through the pipe 12 by moving the conductive contacts 62, 106 axially along a length of the continuous band assembly 28 or 80 from an axially forward position to an axially rearward position. During this time, the voltage differential is measured via the stationary electrical contact.

The present invention also provides methods for measuring a voltage differential within a pipe 12 in which a voltage differential measurement tool 10 is used. In accordance with these methods, a pair of conductive contacts 62 or 106 are urged radially outwardly into stationary electrical contact with the pipe 12. The “pair” of conductive contacts 62 or 106 would include a first conductive contact 62, 106 from the forward continuous band assembly 28a and a second conductive contact 62, 106 from the rearward continuous band assembly 28b. The pair of conductive contacts 62 or 106 have a voltage differential applied between them across a section of pipe 12 over a distance of “d”. The pair of conductive contacts 62 or 106 are moved axially upon a portion of the tool 10 in order to maintain the stationary electrical contact with the pipe 12 for a period of time during which a voltage differential is measured through the pair of conductive contacts 62 or 106.

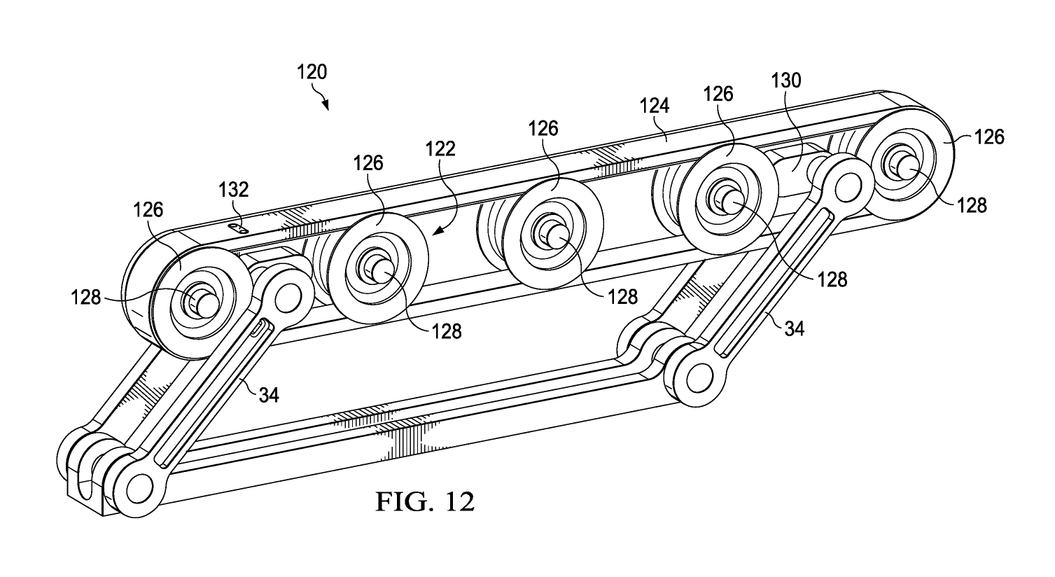

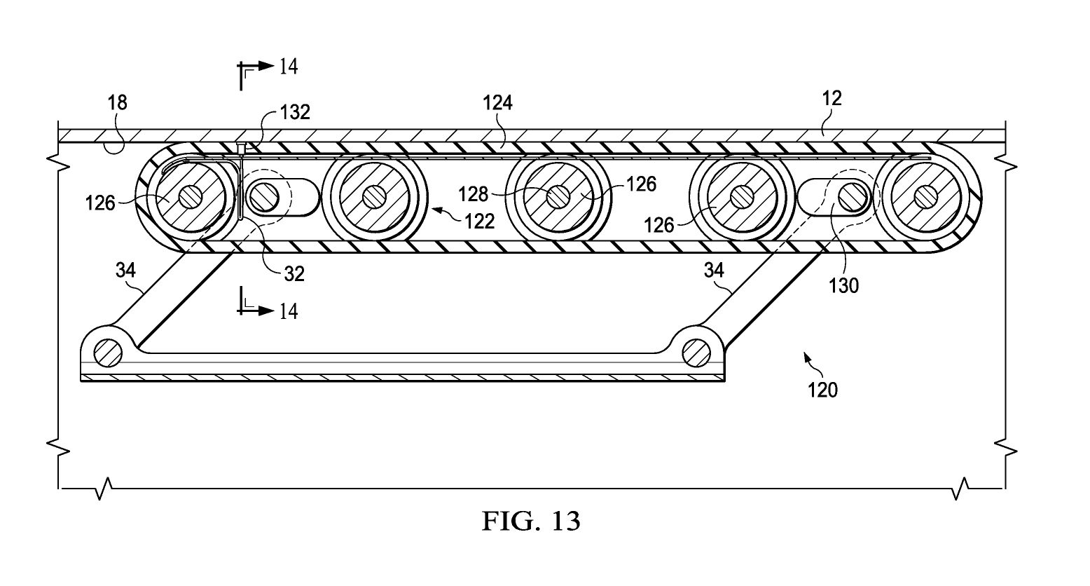

FIGS. 12-14 illustrate an alternative continuous band assembly 120 which can replace any of the continuous band assemblies 28 or 80 described previously. The continuous band assembly 120 includes a roller assembly, generally indicated at 122 and a continuous band in the form of continuous flexible belt 124. The belt 124 may be fashioned of fabric, elastomer or other flexible materials. The roller assembly 122 includes at least one, and preferably a plurality of, rollers 126 which rotate upon axles 128 that are supported by a frame 130. When the tool 10 is disposed within the pipe 12, the belt 124 is in contact with the interior surface 18 of the pipe 12. As the tool 10 moves axially through the pipe 12, frictional engagement between the belt 124 and the interior surface 18 will cause the belt 124 to be circulated upon the roller assembly 122.

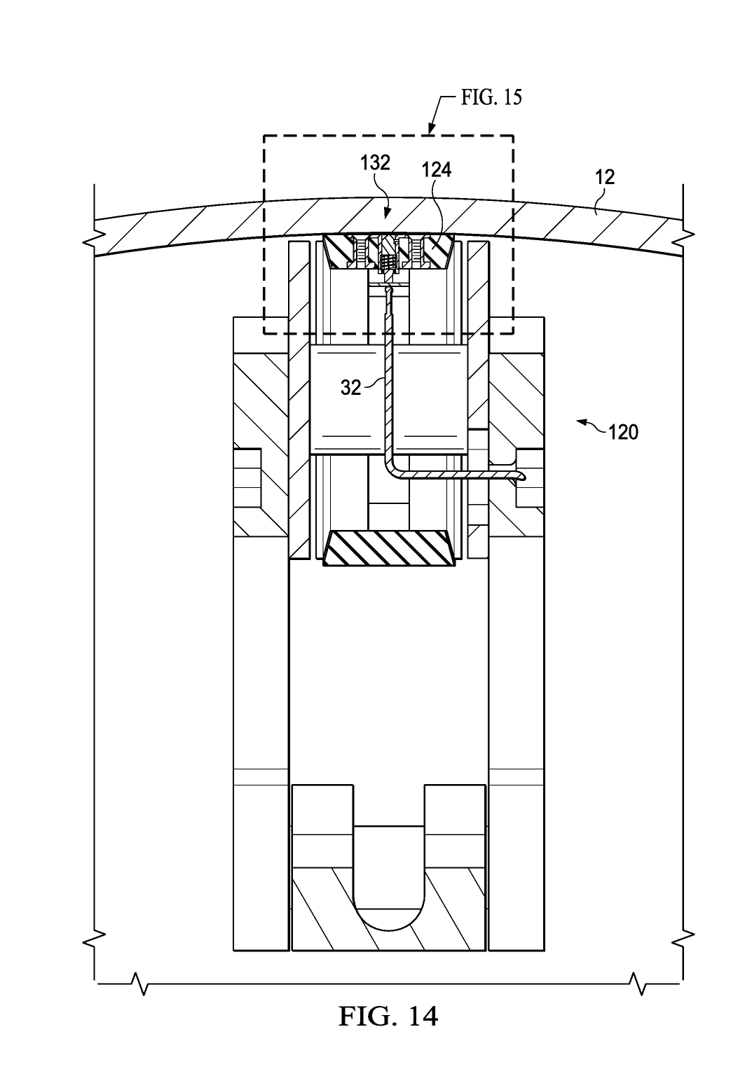

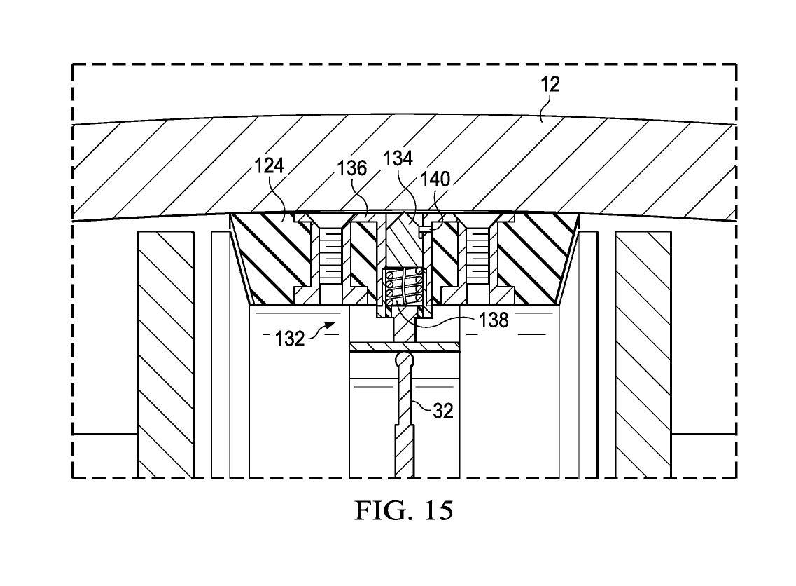

The continuous band assembly 120 carries at least one probe assembly 132. Although only a single probe assembly 132 is illustrated in FIGS. 12-14, it should be understood that there may be more than one such probe assembly carried by the continuous belt 124. Construction of the probe assembly can be seen more clearly with reference to FIGS. 14-15. A contact pin 134 is seated within a contact pin retaining block 136 and is biased radially outwardly from the retaining block 136 by compression spring 138. Retaining pin 140 prevents the contact pin 134 from exiting the retaining block 136. The contact pin 134 and compression spring 138 are electrically conductive and interconnect with wiring 32 to ensure electrical communication between the contact pin 134 and the voltage measurement device 26.

As the tool 10 moves axially through the pipe 12, frictional engagement between the belt 124 and the interior surface 18 substantially prevents the belt 124 from sliding movement upon the interior surface 18. Instead, the belt 124 is circulated upon the roller assembly 122, and this circulation will cause the probe assembly 132 to be brought into stationary, non-sliding contact with the interior surface 18 for a period of time. Thereafter, further axial movement of the tool 10 through the pipe 12 will cause the probe assembly 132 to be removed from contact with the interior surface 18. The probe assembly 132 will be repeatedly brought into and out of contact with the interior surface 18 as the tool 10 continues to move through the pipe 12.

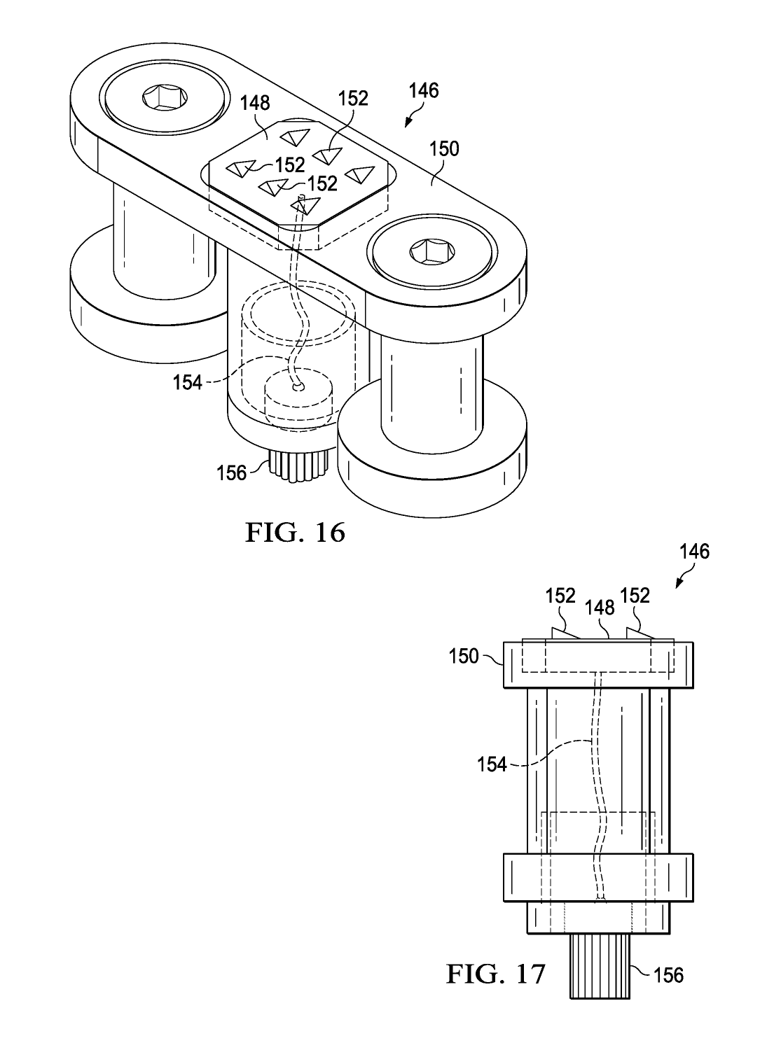

FIGS. 16-17 illustrate an alternative probe assembly 146 which could be used in place of probe assembly 132. A conductive insert 148 is seated within retaining block 150. Teeth 152 extend outwardly from the insert 148 and will create a biting engagement with the interior surface 18 of the pipe 12 when brought into contact with it. A conductive wire 154 connects the conductive insert 148 to conductive brush tuft 156.

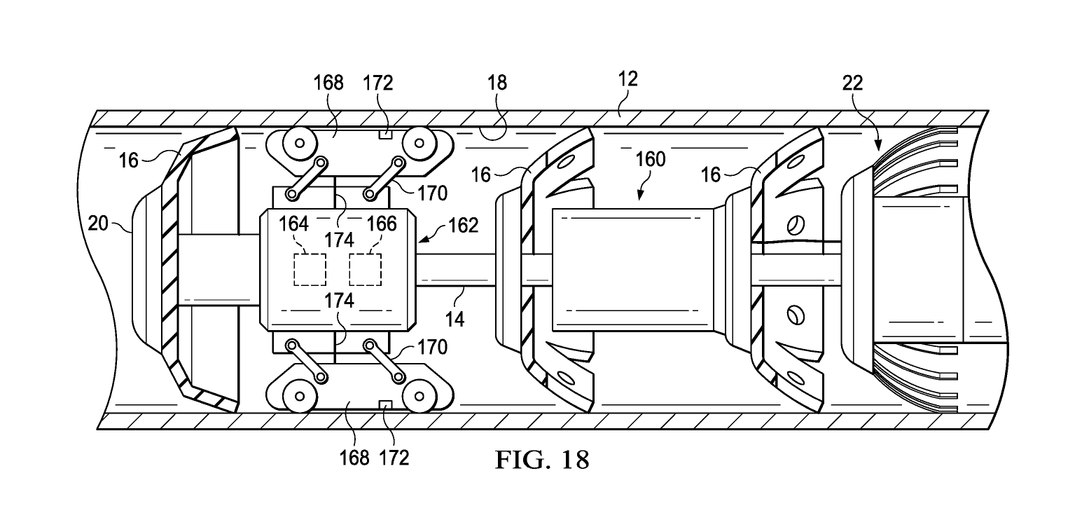

In other aspects, the invention provides devices and methods for bringing other varieties of sensors used with pipe inspection tools into contact with the surrounding pipe. FIG. 18 illustrates an exemplary pipe inspection tool 160 which is constructed and operates in the same manner as inspection tool 10 except where otherwise described here. The pipe inspection tool 160 includes a pipe sensor assembly, generally indicated at 162 which functions to sense or detect one or more pipe condition parameters, such as material hardness, acoustic, ultrasonic or other properties. The pipe sensor assembly 162 includes sensor data memory storage 164 and a power supply 166 which provides power to the memory storage 164 and any sensors within the pipe sensor assembly 162. The pipe sensor assembly 162 also includes at least one sensor platform assembly 168 which extends radially outwardly from the shaft assembly 14 by at least one support arm 170.

The sensor platform assembly 168 may be constructed and operate in the manner described for any of continuous band assemblies 28, 80 or 120 described previously. In place of an electrically conductive contact (such as conductive contacts 62 or 106 or probe assemblies 132 or 146), the sensor platform assembly 168 will carry a sensor 172 which is adapted to detect at least one pipe condition parameter and provide a signal representative of the detected parameter(s) to the sensor data memory storage 164. The sensor(s) 172 is/are carried by the continuous band of the sensor platform assembly 168 and placed into stationary contact with the interior pipe surface 18 in a manner previously described as the continuous band of the sensor platform assembly 168 is circulated about its roller assembly. The sensor(s) 172 may be an acoustic emission sensor, ultrasonic transducer, material hardness tester, eddy coil, Hall effect or other sensor known in the art. Additionally, the sensor(s) 172 can be a contactless or proximity sensor (potted within a molding which will make contact with the pipe 12) which can sense temperature, pressure or magnetic properties of the pipe 12. A data transmission conduit 174 is provided to by which the sensor 172 can transmit signals representative of the sensed pipe condition parameter(s) from the sensor(s) 172 to the sensor data memory storage 164.

It should be understood that the invention generally provides methods for inspecting a pipe 12 to determine at least one pipe condition parameter of the pipe. In accordance with described methods, a pipe inspection tool 10 having at least one continuous band assembly 28, 80 or 120 is disposed into and moved axially through the pipe 12. Movement of the pipe inspection tool 10 through the pipe 12 will circulate a continuous band (i.e, chain drive 46, 90 or belt 124) of the continuous band assembly 28, 80, 120 about a roller (roller or sprocket assemblies 48, 92 or 122). A pipe inspection element, which may be in the form of an electrically conductive contact (62 or 106 or probe assemblies 132 or 146) or a pipe condition sensor 172, is brought into stationary, non-sliding contact with the interior surface 18 of the pipe 12 as the continuous band is circulated upon the roller. Stationary contact between the pipe inspection element and the interior surface 18 is maintained for a period of time as the pipe inspection tool 10 continues to move axially through the pipe 12. Also in accordance with the described methods, further axial movement of the pipe inspection tool 10 through the pipe 12 will cause further circulation of the continuous band about the roller, terminating the stationary contact between the pipe inspection element and the pipe 12. The process of bringing the pipe inspection element into stationary contact with the pipe 12 and then terminating contact is repeated as the pipe inspection tool 10 continues to move axially through the pipe 12.

What is claimed is:

1. A pipe inspection tool comprising:
a central shaft assembly to be inserted into and move axially through the pipe;
a continuous band assembly which extends radially outwardly from the central shaft, the continuous band assembly including:
a continuous band;
a roller for circulating the continuous band thereupon; and
a pipe inspection element carried by the continuous band and which establishes stationary contact with an interior surface of the pipe over a period of time when the continuous band is circulated upon the roller.

2. The pipe inspection tool of claim 1 wherein the continuous band comprises a chain drive.

3. The pipe inspection tool of claim 2 wherein the roller further comprises a sprocket assembly having at least one toothed sprocket for engaging the chain drive.

4. The pipe inspection tool of claim 1 wherein the pipe inspection element comprises a conductive contact which establishes electrical communication between the interior surface of the pipe and a voltage measurement device.

5. The pipe inspection tool of claim 1 wherein the pipe inspection element comprises a sensor to detect at least one pipe condition parameter.

6. The pipe inspection tool of claim 5 wherein the pipe condition parameter is from the group consisting of: voltage differential measurement, material hardness, acoustic or ultrasonic property.

7. The pipe inspection tool of claim 1 wherein each of the continuous band assemblies further comprises a carriage which carries the continuous band and the roller, the carriage being supported from the central shaft assembly by a support arm.

8. The pipe inspection tool of claim 1 wherein the roller is operably interconnected with a pipe-contacting wheel which rolls along the interior surface of the pipe, rolling of the wheel rotating the roller.

9. The pipe inspection tool of claim 1 wherein the continuous band is circulated upon the roller by frictional engagement between the continuous band and the interior surface.

10. The pipe inspection tool of claim 4 wherein:
at least one of the continuous band assemblies further comprises a conductive contact platform which carries the conductive contact, the conductive contact platform pivoting with respect to the continuous band during circulation of the continuous band in order to orient the conductive contact for effective contact with the interior surface of the pipe.

11. The pipe inspection tool of claim 10 further comprising:
a channel formed within a portion of the carriage;
a follower pin which extends from the conductive contact platform and moves within the channel to guide the conductive contact platform during circulation of the continuous band.

12. The pipe inspection tool of claim 1 wherein the continuous band comprises a flexible belt.

13. The pipe inspection tool of claim 1 further comprising a plurality of shaped cups for capturing fluid, the cups extending radially outwardly from the shaft assembly.

14. The pipe inspection tool of claim 4 wherein the conductive contact comprises a conductive tuft assembly, a brush or a probe.

15. A method for inspecting a pipe to determine at least one pipe condition parameter of the pipe, the method comprising:
moving a pipe inspection tool axially through the pipe, the pipe inspection tool having a continuous band assembly which is in contact with the pipe;
circulating a continuous band of the continuous band assembly about a roller to place a pipe inspection element into stationary contact with the pipe; and
maintaining the stationary contact with the pipe for a period of time as the pipe inspection tool moves axially through the pipe.

16. The method of claim 15 further comprising:
further circulation of the continuous band about the roller terminating the stationary contact between the pipe inspection element and the pipe.

17. The method of claim 15 wherein:
the continuous band is rotated about the roller by rolling contact between a wheel which is mounted upon the continuous band assembly and the pipe.

18. The method of claim 15 wherein:
the continuous band is rotated about the roller by frictional engagement between the continuous band and the pipe.
